(19) United States
(12) Patent Application Publication
(10) Pub. No.: US 2022/0309786 A1
(43) Pub. Date: Sep. 29, 2022

(54) METHOD FOR TRAINING A SUPERVISED ARTIFICIAL INTELLIGENCE INTENDED TO IDENTIFY A PREDETERMINED OBJECT IN THE ENVIRONMENT OF AN AIRCRAFT

(71) Applicant: AIRBUS HELICOPTERS, Marignane Cedex (FR)

(72) Inventors: Francois-Xavier FILIAS, Pelissanne (FR); Richard PIRE, Istres (FR)

(73) Assignee: AIRBUS HELICOPTERS, Marignane Cedex (FR)

(21) Appl. No.: 17/696,967

(22) Filed: Mar. 17, 2022

(30) Foreign Application Priority Data
Mar. 25, 2021 (FR) 2102995

(51) Int. Cl. G06V 20/20; G06V 10/778; G06V 10/776; G06V 20/10; G06V 10/20; G06V 10/82

(52) U.S. Cl. CPC G06V 20/20; G06V 10/7792; G06V 10/776; G06V 20/176; G06V 10/255; G06V 10/82

(57) ABSTRACT

A method for training an artificial intelligence intended to identify a predetermined object in the environment of an aircraft in flight. The method comprises steps of identifying at least one predetermined object in representations representing at least one predetermined object and its environment, establishing a training set and a validation set, the training set and the validation set comprising a plurality of representations from the representations representing at least one predetermined object, training the artificial intelligence with the training set and validating the artificial intelligence with the validation set. The artificial intelligence may then be used, in a method for assisting the landing of the aircraft, to identify a helipad where the landing operation may be performed. The artificial intelligence may also be used, in a method for avoiding a cable, to identify cables situated on or close to the trajectory of the aircraft.

### CROSS REFERENCE TO RELATED APPLICATIONS

This application claims priority to French patent application No. FR 21 02995 filed on Mar. 25, 2021, the disclosure of which is incorporated in its entirety by reference herein.

### TECHNICAL FIELD

The present disclosure relates to the field of flying aids for aircraft. Such aids may, for example, be intended to assist a pilot when landing a rotorcraft, in particular by helping identify a landing area, guide the aircraft towards the landing area and/or land it on such a landing area. Such aids may also be provided to identify and avoid obstacles, such as cables.

### BACKGROUND

The present disclosure relates to a method for training a supervised artificial intelligence intended to identify a predetermined object, for example a helipad or a cable, in the environment of an aircraft. The present disclosure also relates to a landing assistance system and method for an aircraft. The present disclosure further relates to a system and a method for assisting cable avoidance with an aircraft.

It may be difficult for a crew of an aircraft to identify a landing area when, for example, this landing area is arranged on a building, which may be mobile. Such a building may, in particular, be in the form of a vehicle, such as a ship, a barge or a platform, which may comprise several separate landing areas.

Identifying a landing area may prove even more complex when the landing area is positioned in a large zone comprising, for example, a group of several buildings or platforms that are geographically close to one another.

Moreover, a landing area may sometimes be located within a congested environment and/or may have limited dimensions with respect to this environment.

For example, a landing area of a marine drilling rig may be small in size. Such a landing area may also be located close to obstacles, such as metal structures, a crane, etc.

Consequently, in practice, the crew of an aircraft must take time to reconnoiter the zone in order to identify the landing area. This time can be particularly substantial if the zone comprises several buildings and/or several landing areas. This results in a high workload for the crew. Moreover, the aircraft needs to carry an additional quantity of fuel to take into account the time required for this reconnaissance operation.

A landing area may be referred to as a “heliport” when located on land, for example, and more generally by the term “helipad”. A helipad may in particular be a landing area situated, for example, on a ship or on a fixed or floating marine platform such as a marine drilling rig.

Any helipad has visual features that allow a pilot to identify it in conditions of sufficient visibility. Helipads may be of various shapes, for example square, circular or triangular, and of particular colors, for example yellow or white, and optionally include a letter “H” printed in the center and/or a circle. Helipads may also be illuminated. The dimensions of the letter “H” and/or of the circle printed on a helipad may in particular comply with a standard prescribed in the document “CAP 437: Standards for offshore helicopter landing areas”.

In order to help identify a helipad and land on that helipad, an aircraft may use a piloting assistance method or device.

For example, document FR 3 062 720 describes a method that involves capturing images of a helipad, using a first imaging system to calculate a position of the helipad based on at least one captured image, using an autopilot system to determine a current position of the helipad at the current point in time, using a second imaging system to verify the presence of the helipad at this current position in a captured image, and generating an alarm if this presence is not verified.

Document FR 3 053 821 describes a method and a device for assisting the piloting of a rotorcraft, for helping to guide a rotorcraft to a landing area on a helipad. This device comprises, in particular, a camera for capturing a plurality of images of the environment of the rotorcraft along a line of sight and image processing means for identifying at least one sought helipad in at least one image. The method implemented by this device includes a step of preselecting a type of helipad, a step of acquiring images of the environment of the rotorcraft, a processing step for identifying at least one helipad corresponding to the preselected type of helipad in at least one image, a display step for displaying an image representative of said at least one helipad, a selection step for selecting a helipad from said at least one displayed helipad, and a control step for generating a control setpoint for automatically piloting the rotorcraft towards the selected helipad.

Moreover, a horizon line can first of all be detected in the context of image processing by means of a method referred to as the gradient method, using a vertical Sobel filter on at least one captured image. Next, a “Hough transform” may be applied in order to detect, for example, aligned points or simple geometric shapes in a complex image in order to identify, for example, the letter “H” or a part of a circle printed on the helipad.

Document FR 3 089 038 describes a method for training a neural network on board an aircraft in order to help a pilot of the aircraft land on a landing strip in reduced visibility conditions. Radar images of several landing strips in which the landing strips are identified are captured in clear weather by a fleet of aircraft. These radar images form a database used to train the neural network. The neural network is then installed in the aircraft and makes it possible to display information relating to the position of the targeted landing strip overlaid on a view of the external environment, or even to control the landing of the aircraft, by means of an autopilot system.

Furthermore, an aircraft crew must also monitor the possible presence of cables on or near the flight path of the aircraft. However, an aircraft crew may have difficulty detecting such a cable because of its filiform geometry. This detection is, nevertheless, important in order to modify the trajectory of the aircraft, if necessary, in order to give a detected cable a sufficiently wide berth.

Document FR 2 888 944 describes a method for detecting the presence of a suspended filiform object, such as a cable, in the field of view of a range finder on board an aircraft. This method may use a Hough transform to detect one or more aligned points in a horizontal plane of this field of view. A catenary shape can then be identified from a group of detected points, and parameters of this catenary are calculated in order to confirm or deny the presence of a suspended filiform object.

However, the methods of the prior art, relating to the identification both of a helipad and of a cable, require not-insignificant, and indeed substantial, calculation times, in order to be certain of detecting and identifying the predetermined objects present in the environment.

Furthermore, document WO 2020/152060 describes a method for training a neural network. According to the method, an evaluation device and a neural network operate in parallel. The neural network is intended to provide a predetermined functionality for processing input data and the evaluation device is intended to provide the same predetermined functionality. Comparing the output data of the evaluation device and the neural network makes it possible to determine the quality of the results of the neural network with respect to the results of the evaluation device. A feedback device is provided for reporting to the neural network the quality of the output data determined by the comparison device in order to produce a training effect for the neural network and, therefore, an improvement in the quality of the results of the neural network.

The publication “Runway Detection and Localization in Aerial Images using Deep Learning” by Javeria Akbar et al., dated 2 Dec. 2019 (IEEE, XP033683070), describes a method for detecting landing strips in aerial images, using deep learning. According to this method, a landing strip can be identified by detecting line segments in an image by applying a Hough transform or an approach referred to as the LSD (Line Segment Detector) approach. A convolutional neural network (CNN) intended for detecting landing strips uses a database of aerial images comprising different landing strips for its training and validation.

The publication “A Review of Road Extraction from Remote Sensing Images” by Weixing Wang et al. dated 17 Mar. 2016 (Journal of Traffic and Transportation Engineering, XP055829931) describes different methods for extracting roads present in images. These methods may use the geometric characteristics, the photometric characteristics or the textural characteristics of the roads. For example, these methods use an artificial neural network (ANN), a BP (backpropagation) neural network, a supervised learning method (SVM), etc. The contours of a road can be identified in an image, for example by the method referred to as the snake method, a least squares method, for example.

Document CN 109 543 595 describes a method for detecting cables using a convolutional neural network. After a training cycle, the convolutional neural network analyzes images in real time and extracts the potential obstacles, for example cables, and displays them, thus providing an alert for a pilot of a helicopter.

Document US 2017/0045894 describes several procedures or systems for the autonomous landing of drones. This document describes, for example, the use of a computer vision algorithm configured to identify and track several landing areas in an environment, by detecting landing areas by means of a circle, a marker, the letter “H”, for example. A neural network and/or similar approaches may be used to process the data in order to identify the available landing areas. These methods use a finite and specific set of identification symbols, thereby reducing all the traditional training requirements.

### SUMMARY

The aim of the present disclosure is therefore to propose an alternative method and system for detecting and identifying predetermined objects present in the environment of an aircraft with very short calculation times so as to identify at least one predetermined object substantially in real time.

The object of the present disclosure is, for example, a method for training a supervised artificial intelligence intended to identify a predetermined object in the environment of an aircraft in flight.

The object of the present disclosure is also a method and a system for assisting the landing of an aircraft and an aircraft provided with such a system. Finally, the object of the present disclosure is a method and a system for assisting cable avoidance with an aircraft and an aircraft provided with such a system.

First and foremost, the object of the present disclosure is a method for training a supervised artificial intelligence intended to identify a predetermined object in the environment of an aircraft in flight.

The method according to the disclosure is remarkable in that it includes the following steps carried out using a calculator:

identifying at least one predetermined object by processing representations representing at least one predetermined object and at least part of its environment, said representations comprising a plurality of representations of the same predetermined object with different values of at least one characteristic parameter of said representation;

establishing a training set and a validation set to feed the supervised artificial intelligence comprising the following sub-steps:
selecting a plurality of representations from said identified representations to form the training set; and
selecting a plurality of representations from said identified representations to form the validation set;

training in order to train the supervised artificial intelligence, using at least the training set; and

validating in order to validate the supervised artificial intelligence, using at least the validation set.

In this way, the supervised artificial intelligence is trained and validated in order to be able to identify one or more predetermined objects in images that are analyzed and processed by this supervised artificial intelligence. The calculation times required by the supervised artificial intelligence to identify a predetermined object in this way are, in particular, very short and compatible with in-flight applications, because they make it possible to detect and identify a predetermined object in the environment of the aircraft substantially in real time.

The supervised artificial intelligence is advantageously particularly effective for detecting and identifying any predetermined object whose characteristics are previously known, present in an image captured in flight by an image capture device on board an aircraft. The characteristics of such a predetermined object, and in particular its geometric characteristics, are previously known, this predetermined object being in particular present in one or more representations used for the step of training the supervised artificial intelligence.

The supervised artificial intelligence may comprise, for example, a multilayer neural network, also referred to as a “multilayer perceptron”, or a support-vector machine. Other artificial intelligence solutions may also be used. For example, the neural network comprises at least two hidden neural layers.

The predetermined object may be a helipad or a suspended cable, for example. The supervised artificial intelligence can thus be applied, during a flight of an aircraft and, more particularly, of a rotorcraft, to the detection and identification of a helipad with a view to performing a landing operation, or a suspended cable in order to avoid this cable.

The representations used and representing at least one predetermined object and at least part of its environment may comprise different types of representations.

The representations used may, for example, comprise images containing at least one predetermined object and at least part of its environment, such as photographs, captured for example by means of cameras or photographic devices from aircraft flying in the vicinity of this at least one predetermined object. When the predetermined object is a helipad, the images may have been captured during an approach phase with a view to landing or during one or more flights dedicated to capturing these images. When the predetermined object is a suspended cable, the images may have been captured during a flight close to this cable or during one or more flights dedicated to capturing these images.

The representations used may also comprise images from a terrain database, for example a database obtained using a LIDAR (Light Detection And Ranging) sensor, the terrain data possibly being in two dimensions or in three dimensions.

The representations used may also comprise computer-generated synthetic images, for example, or else images provided by a satellite. The representations used may also include other types of images.

Irrespective of the types of images or representations of said at least one predetermined object, the representations used comprise a plurality of representations of the same predetermined object with different values of at least one characteristic parameter of these representations.

Said at least one characteristic parameter of these representations comprises one or more criteria, for example a distance of a predetermined object in the representations or an angle of view of this predetermined object in the representations, the predetermined object thus being represented in several different representations at different distances and/or at different angles of view.

Said at least one characteristic parameter of these representations may also include an accumulation criterion for the representation, a noise criterion for the representation or a similarity factor criterion for said representation. A predetermined object can thus be represented in a plurality of representations with different values for this accumulation criterion, this noise criterion and/or this similarity factor criterion.

The accumulation criterion is a characteristic related to the image processing performed on the representation following the application of a Hough transform. For the application of a Hough transform, the accumulation criterion is, for example, equal to three in order to identify a line that passes through three points. This accumulation criterion is defined empirically through tests and experiments.

The noise criterion, which may be associated with the notion of variance, and the similarity factor criterion, also referred to as “matching”, may characterize quality levels of a representation or attached to a predetermined object in a representation.

The values of the accumulation, noise and/or similarity factor criteria associated with a representation may be a function of the estimated distance of the predetermined object in the representation as well as other phenomena such as, for example, a false echo rate related to rain or dust.

A predetermined object may also be represented in a plurality of representations with varying weather conditions, namely clear weather, rainy weather, fog, day or night conditions, etc.

A predetermined object may also be represented in a plurality of representations originating from the same initial representation, for example a photograph, in particular by modifying the colors, the contrast and/or the brightness of the initial representation.

The use of a plurality of representations of the same predetermined object with different values of one or more characteristic parameters of these representations makes it possible for the identification of at least one predetermined object by processing representations to be considered to be a parametrized identification.

Thus, the training of the supervised artificial intelligence makes it possible to take into account, in particular, various points of view and various weather conditions in order to obtain a reliable and effective artificial intelligence.

The method according to the disclosure may include one or more of the following features, taken individually or in combination.

According to one possibility, the step of identifying at least one predetermined object by processing representations may comprise the following sub-steps:

processing the representations by applying one or more image processing methods from a Sobel filter, a Hough transform, the least squares method, the snake method and the image matching method, in order to detect at least one parametrizable geometric shape;

identifying, in each of the representations, at least one predetermined object, by means of this at least one geometric shape; and

storing, for each of the representations, the representation and the at least one identified predetermined object.

For example, a parametrizable geometric shape may be an ellipse in order to identify a circle drawn on a helipad.

A parametrizable geometric shape may also be a line segment formed by an alignment of points in order to identify the edges forming the letter “H” printed on a helipad.

More generally, any geometric shape that is parametric and, therefore, parametrizable can be detected, for example by implementing a Hough transform from m to 1 or from 1 to m, m being the number of parameters of the geometric shape to be found.

Such a line segment or other particular geometric shape can also be used to identify a characteristic element of the environment of the predetermined object, such as one or more edges of a building, an element of a metal structure or an element of a pylon located close to the predetermined object, or indeed supporting the predetermined object. In this case, the line segment or the particular geometric shape do not make it possible to directly identify the predetermined object, but make it possible to identify part of its environment.

A parametrizable geometric shape may also be a catenary in order to identify a suspended cable, for example.

Such a parametrizable geometric shape, namely an ellipse, a line segment, a catenary or the like, may thus constitute a geometric characteristic of the predetermined object.

The step of identifying at least one predetermined object in each of the representations by means of this at least one geometric shape may be carried out using the accumulation criteria compared with thresholds that allow such detection within the context of the Hough transform.

The storing, for each of the identified representations, of the representation and of each identified predetermined object, is carried out on a memory connected to the calculator or a memory which the calculator comprises. Each identified predetermined object is stored, for example, by storing one or more geometric characteristics associated with the parametrizable geometric shape used to detect and identify this predetermined object.

According to one possibility, the step of identifying at least one predetermined object may comprise a sub-step of automatically labelling at least one predetermined object in a representation, this labelling comprising at least one labelling parameter from the geometric shape of the predetermined object, definition parameters of such a geometric shape of the predetermined object, and positioning parameters of the predetermined object, for example.

The definition parameters of a geometric shape of a predetermined object may comprise parameters of the equation or equations defining said geometric shape in space, with a view to reconstructing it with a synthetic imaging system, for example. The definition parameters of a geometric shape of a predetermined object may also comprise dimensions of said geometric shape, for example the lengths of a small axis and a large axis, in the case of an ellipse.

The positioning parameters of the predetermined object may be dependent on the on-board installation making it possible to obtain the representation of the predetermined object, such as a camera or a photographic device or indeed a LIDAR sensor. A positioning parameter of the predetermined object may therefore be a focal distance of the lens of the on-board installation, or a bias of this on-board installation, for example.

Furthermore, the sub-step of automatically labelling at least one predetermined object in a representation may be carried out before carrying out the method for training a supervised artificial intelligence intended to identify a predetermined object in the environment of an aircraft in flight.

The sub-step of selecting the training set may be carried out according to at least one labelling parameter.

According to one possibility, the sub-steps of selecting the training set and selecting the validation set are carried out according to at least one characteristic parameter of said representations, for example a single characteristic parameter or according to several combined characteristic parameters.

For example, the sub-step of selecting the training set may be carried out according to the accumulation criterion.

For example, the sub-step of selecting the training set is carried out with 1000 representations identified as input, including:

600 representations with a very high accumulation criterion, corresponding to representations at a short distance and comprising a single predetermined object;

300 representations with a high accumulation criterion, corresponding to representations at a medium distance and comprising a single predetermined object; and

100 representations with a low accumulation criterion, corresponding to representations at a long distance and comprising several predetermined objects.

The sub-step of selecting the validation set may also be performed according to the accumulation criterion. Furthermore, the representations of the validation set may be different from the representations of the training set.

The sub-step of selecting the training set and/or the sub-step of selecting the validation set may also be carried out according to the noise criterion and/or the similarity factor criterion of the representations or indeed the distance of a predetermined object in the representations.

In this way, the sub-steps of selecting the training set and/or selecting the validation set can be considered to be parametrized selections.

In addition, an iterative process may be associated with the selection of the representations forming the training and validation sets, depending on the robustness of the desired supervised artificial intelligence.

For example, when the supervised artificial intelligence comprises a multilayer network, the steps of training and validating the supervised artificial intelligence may make it possible to determine an optimal number of neurons per layer and an optimal number of neuron layers, as well as the activation functions of the neurons.

Indeed, there is an optimal number of neurons per layer and an optimal number of neuron layers in order to precisely and extremely quickly identify the predetermined object or objects present in an image. Indeed, too few layers and/or too few neurons per layer can result in the non-detection of a predetermined object. Conversely, too many layers and/or too many neurons per layer can degrade the end result, due to a non-optimized calculation time.

For this purpose, during the steps of training and validating the neural network, the number of neurons and the number of neuron layers are determined by iteration until an expected result is obtained for the identification of the predetermined object or objects present in the representations during the validation step. The expected result is, for example, the precision of the parameters of the parametrized geometric shape output by the neural network.

If the expected result is not achieved, the training and validation steps are performed again, increasing the number of layers and the number of neurons per layer. If the expected result is achieved, the neural network is validated with the number of layers and the number of neurons per layer used.

In addition, the choice of the activation function associated with each neuron also influences the performance and the precision of the neural network. Thus, during an iteration, the activation functions of the neurons can also be modified.

Such an optimization of the neural network, of the activation functions of the neurons, of the number of layers and of the number of neurons per layer therefore makes it possible, in particular, to optimize the calculation time, without the need for an on-board calculator provided with high computing power and that is consequently large and expensive.

Such a neural network uses, as input data, the representations in which at least one identified predetermined object is present as well as the value of at least one criterion associated with each representation, for example an accumulation criterion, a noise criterion and/or a similarity factor criterion. The output data of the neural network comprise, for example, the parameters of the detected geometric shape and the values of this at least one criterion associated with each representation.

According to one possibility, the sub-steps of selecting the training set and selecting the validation set are carried out by random selection from the identified representations. The representations of the validation set may be entirely or partially different from the representations of the training set.

According to one possibility, the representations are limited to predetermined objects situated in a determined geographical area. The representations are limited to predetermined objects located, for example, in a country, a region or a city. This limitation of the geographical area can therefore make it possible to limit the size of the supervised artificial intelligence required and to minimize the calculation time required by the supervised artificial intelligence to identify a predetermined object.

The object of the present disclosure is also a method for assisting the landing of an aircraft, the aircraft comprising at least one on-board calculator and at least one image capture device connected to the calculator, the method being implemented by the calculator.

For convenience, this at least one calculator is referred to hereinafter as the “specific calculator” and this at least one image capture device is referred to hereinafter as the “specific image capture device”. Similarly, a memory and a display device associated with this method for assisting the landing of an aircraft are referred to respectively as the “specific memory” and the “specific display device”. The adjective “specific” does not limit the use of these elements only to this method.

For example, the specific image capture device may include at least one camera or photographic device that captures images of a zone situated in front of the aircraft.

The method for assisting the landing of an aircraft comprises the following steps:

acquiring at least one image of an environment of the aircraft using said at least one specific image capture device; and

identifying at least one helipad in the environment by processing said at least one image with the supervised artificial intelligence by means of the specific calculator, the supervised artificial intelligence being defined using the previously described training method, the predetermined object being a helipad, the supervised artificial intelligence being stored in a specific memory connected to the specific calculator.

This method for assisting the landing of an aircraft thus makes it possible to automatically identify, as soon as possible and in a rapid manner, by means of the supervised artificial intelligence and images captured by said at least one specific image capture device, one or more helipads present in the environment of the aircraft, thus relieving the pilot and/or the co-pilot of this search. This method for assisting the landing of an aircraft makes it possible to automatically identify one or more helipads, including in the event of poor weather conditions, rain or fog, and possibly at night, by identifying the helipad or helipads, for example by means of geometric characteristics of the helipad or helipads, and possibly characteristic elements of the environment helping determine the helipad or helipads.

The helipad or helipads identified in the environment of the aircraft, and their geometric characteristics, may be known previously.

In order to indicate the presence of at least one helipad, this method may comprise a step of displaying, on a specific display device of the aircraft, a first identification marker in overlay on the at least one identified helipad in an image representing the environment of the aircraft or indeed in a direct view of the environment through the specific display device. The specific display device may be a head-up display, a screen arranged on an instrument panel of the aircraft, or indeed part of a windshield of the aircraft.

This method may also include a step of determining at least one helipad available for a landing operation from said at least one identified helipad.

For this purpose, the supervised artificial intelligence may identify the presence of a helipad while detecting that the view is not consistent with its perception at the time of training. For example, the letter “H” printed on the helipad may not be identified or may not be totally visible.

A low value for the accumulation criterion for the letter “H” and a high value for the accumulation criterion for the ellipse printed on the helipad may, for example, indicate the presence of a vehicle on the helipad, this helipad then being considered to be occupied by a vehicle and consequently not available for a landing operation. The presence of a helipad considered to be occupied by a vehicle and therefore not available for a landing operation may be taken into account when training the supervised artificial intelligence and may be an output datum of this supervised artificial intelligence.

This method may then comprise a step of displaying, on the specific display device, a second identification marker in overlay on said at least one helipad available for a landing operation in an image representing the environment of the aircraft or indeed in a direct view of the environment through the specific display device. This method may also comprise a step of displaying, on the specific display device, a third identification marker in overlay on said at least one helipad occupied by a vehicle and consequently not available for a landing operation in an image representing the environment of the aircraft or indeed in a direct view of the environment through the specific display device.

This method may also comprise the following additional steps:

selecting a helipad in order to carry out a landing operation on the helipad selected from said at least one identified helipad;

determining a position of the selected helipad;

determining a setpoint for guiding the aircraft to the selected helipad using the specific calculator; and

automatically guiding the aircraft towards the selected helipad by means of an autopilot device of the aircraft.

The selection of the helipad on which a landing operation is to be carried out may be made manually by a pilot or a co-pilot of the aircraft, for example by means of a touch panel or a pointer associated with the specific display device displaying the environment of the aircraft and said at least one identified helipad.

This selection of the helipad on which a landing operation is to be carried out may also be made automatically, in particular when only one helipad is identified or when only one helipad of the identified helipads is available for a landing operation.

The determined position of the selected helipad is a position relative to the aircraft determined, for example, by an operation for processing the images captured by the specific image capture device, performed using the specific calculator, possibly associated with a calculation, for example via an algorithm, as a function of the characteristics of the specific image capture device. The characteristics of the specific image capture device include, for example, the focal distance used, as well as the orientation of the specific image capture device relative to the aircraft, i.e., the elevation and the bearing.

Knowing one or more geometric characteristics of the selected helipad, such as the dimensions of the letter, for example “H”, printed on this helipad, or the diameter of a circle drawn on the helipad, also makes it possible, in association with the characteristics of the specific image capture device, to determine the relative position of the selected helipad with respect to the aircraft.

The setpoint is then determined as a function of this relative position and updated when the aircraft has approached the selected helipad.

This setpoint is transmitted to the autopilot device of the aircraft in order to automatically approach the selected helipad.

This method may also include a final step of landing on the selected helipad automatically by means of the autopilot device.

In addition, the method may include a step of calculating a distance between said at least one identified helipad and the aircraft. When a single helipad is identified, a single distance is calculated and is equal, for example, to the distance between the center of the identified helipad and the aircraft. When several helipads are identified, several distances are calculated and are respectively equal, for example, to the distance between the center of each of the identified helipads and the aircraft.

Such a distance is calculated by the specific calculator depending on the relative position of an identified helipad with respect to the aircraft, as a function of one or more geometric characteristics of this helipad, the geometric shapes associated with these geometric characteristics represented on said at least one captured image, and the characteristics of the specific image capture device.

The method may also include a step of displaying the calculated distance or distances on the specific display device. For example, a distance is displayed next to the corresponding helipad on the specific display device.

The object of the present disclosure is also a system for assisting the landing of an aircraft, the system comprising:

at least one on-board specific calculator;

at least one specific memory connected to the specific calculator; and

at least one specific image capture device connected to the specific calculator.

The aircraft may also include a specific display device and/or an autopilot device.

The system is configured to implement the method for assisting the landing of an aircraft as described above.

The object of the present disclosure is also an aircraft comprising such a system for assisting the landing of an aircraft.

The object of the present disclosure is also a method for assisting cable avoidance with an aircraft, the aircraft comprising at least one on-board calculator and at least one image capture device connected to the calculator, the method being implemented by the calculator.

For convenience, this at least one calculator is hereinafter referred to as the “designated calculator” and this at least one image capture device is hereinafter referred to as the “designated image capture device”. Similarly, a memory and a display device associated with this method for assisting cable avoidance with an aircraft are referred to respectively as the “designated memory” and the “designated display device”. The adjective “designated” does not limit the use of these elements only to this method.

The method includes the following steps:

acquiring at least one image of an environment of the aircraft using said at least one designated image capture device; and

identifying at least one cable in the environment by processing the images with the supervised artificial intelligence by means of the designated calculator, the supervised artificial intelligence being defined using the previously described training method, the predetermined object being a cable, the supervised artificial intelligence being stored in a designated memory connected to the designated calculator.

This method for assisting cable avoidance with an aircraft thus makes it possible to automatically identify, as soon as possible and in a rapid manner, by means of the supervised artificial intelligence and images captured by said at least one designated image capture device, one or more cables present in the environment of the aircraft and likely to be located on or close to the trajectory of the aircraft. The pilot and/or the co-pilot are therefore relieved of this search and can concentrate, in particular, on piloting the aircraft. This method for assisting cable avoidance with an aircraft makes it possible to automatically identify one or more cables, including in the event of poor weather conditions, rain or fog, and possibly at night, by identifying the cable or cables, for example by means of geometric characteristics of the cable or cables, and characteristic elements of the environment.

The cable or cables identified in the environment of the aircraft, and their geometric characteristics, may be known previously.

In order to indicate the presence of at least one cable, this method may comprise a step of displaying, on a designated display device of the aircraft, an identification symbol in overlay on said at least one identified cable in an image representing the environment of the aircraft or indeed in a direct view of the environment through the designated display device. The designated display device may be a head-up display, a screen arranged on an instrument panel of the aircraft, or indeed part of a windshield of the aircraft. The specific display device and the designated display device may be the same display device.

This method may comprise the following additional steps:

determining a position of said at least one identified cable;

determining a guidance setpoint for the aircraft avoiding said at least one identified cable using the designated calculator; and

automatically guiding the aircraft according to the guidance setpoint by means of an autopilot device of the aircraft.

The determined position of an identified cable may be a position relative to the aircraft determined, for example, by an operation for processing the images captured by the designated image capture device, performed using the designated calculator, possibly associated with a calculation, for example via an algorithm, as a function of the characteristics of the designated image capture device. The characteristics of the designated image capture device include, for example, the focal distance used, as well as the orientation of the designated image capture device relative to the aircraft, i.e., the elevation and the bearing.

Knowing one or more geometric characteristics of said at least one identified cable, such as its length or its radius of curvature, also makes it possible, in association with the characteristics of the designated image capture device, to determine the relative position of said at least one identified cable with respect to the aircraft.

The setpoint is then determined as a function of this relative position and updated after the aircraft has moved relative to said at least one identified cable.

The determined position of an identified cable may also be an absolute position in a terrestrial reference frame, for example. This absolute position may be recorded in a dedicated database.

This setpoint is then transmitted to the autopilot device of the aircraft in order to automatically implement a flight path avoiding said at least one identified cable.

In addition, the method may include a step of calculating a distance between said at least one identified cable and the aircraft. This distance is calculated as a function of the relative position of the identified cable with respect to the aircraft. When a single cable is identified, a single distance is calculated and is equal, for example, to the shortest distance between the identified cable and the aircraft. When several cables are identified, several distances are calculated and are respectively equal, for example, to the shortest distance between each of the identified cables and the aircraft.

Such a distance is calculated by the designated calculator depending on the relative position of an identified cable with respect to the aircraft, as a function of one or more geometric characteristics of this cable, the geometric shapes associated with these geometric characteristics represented on said at least one captured image, and the characteristics of the designated image capture device.

The method may also include a step of displaying the calculated distance or distances on the designated display device. For example, a distance is displayed next to the corresponding cable on the designated display device.

The object of the present disclosure is also a system for assisting cable avoidance with an aircraft, the system comprising:

at least one on-board designated calculator;

at least one designated memory connected to the designated calculator; and

at least one designated image capture device connected to the designated calculator.

The aircraft may also include a designated display device and/or an autopilot device.

The system is configured to implement the method for assisting cable avoidance as described above.

The object of the present disclosure is also an aircraft comprising such a system for assisting cable avoidance with an aircraft.

### BRIEF DESCRIPTION OF THE DRAWINGS

The disclosure and its advantages appear in greater detail in the context of the following description of embodiments given by way of illustration and with reference to the accompanying figures, in which:

FIG. 1 is a view of an aircraft comprising a system according to the disclosure;

FIG. 2 is a block diagram of a method for training a supervised artificial intelligence intended to identify a predetermined object;

FIG. 3 is a block diagram of a method for assisting the landing of an aircraft;

FIG. 4 is a view comprising helipads;

FIG. 5 is a block diagram of a method for assisting cable avoidance with an aircraft; and

FIG. 6 is a view comprising suspended cables.

### DETAILED DESCRIPTION

Elements that are present in more than one of the figures are given the same references in each of them.

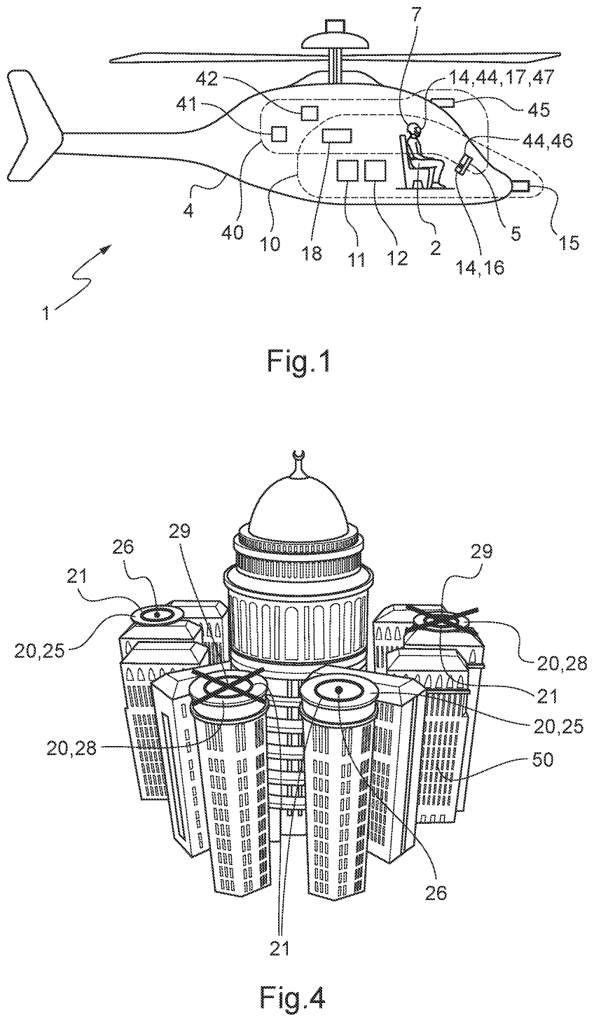

FIG. 1 shows an aircraft 1 provided with an airframe 4. A pilot 2 is positioned inside the airframe 4. The aircraft 1 shown in FIG. 1 is an aircraft provided with a rotary wing. In the context of the disclosure, the aircraft 1 may be another type of aircraft, and may comprise, for example, a plurality of rotary wings.

The aircraft 1 also comprises a system 10 for assisting the landing of the aircraft 1 and a system 40 for assisting cable avoidance with the aircraft 1.

The system 10 for assisting the landing of the aircraft 1 comprises an on-board specific calculator 11, a specific memory 12, a specific image capture device 15, at least one specific display device 14 and possibly an autopilot device for the aircraft 1. The specific calculator 11 is connected to the specific memory 12, to the specific image capture device 15, to each specific display device 14 and to the possible autopilot device 18, via wired or wireless links. The specific calculator 11 can thus communicate with these elements of the system 10 for assisting the landing of the aircraft 1.

The system 40 for assisting cable avoidance with an aircraft 1 comprises a designated calculator 41, a designated memory 42, a designated image capture device 45, at least one designated display device 44 and the possible autopilot device 18 of the aircraft 1. The designated calculator 41 is connected to the designated memory 42, to the designated image capture device 45, to each designated display device 44 and possibly to any autopilot device 18, via wired or wireless links. The designated calculator 41 can thus communicate with these elements of the system 40 for assisting cable avoidance.

By way of example, the calculators 11, 41 may comprise at least one processor and at least one memory, at least one integrated circuit, at least one programmable system, or at least one logic circuit, these examples not limiting the scope to be given to the term “calculator”. The term “processor” may refer equally to a central processing unit (CPU), a graphics processing unit (GPU), a digital signal processor (DSP), a microcontroller, etc.

Said at least one specific display device 14 comprises, for example, a specific screen 16 positioned on an instrument panel 5 of the aircraft 1 and/or a specific viewing device 17 arranged on a helmet 7 of the pilot 2.

Said at least one designated display device 44 comprises, for example, a designated screen 46 positioned on the instrument panel 5 and/or a designated viewing device 47 arranged on the helmet 7 of the pilot 2.

The screens 16, 46 positioned on an instrument panel 5 may be separate, as shown in FIG. 1. The screens 16, 46 may alternatively form a single screen.

The viewing devices 17, 47 arranged on the helmet 7 of the pilot 2 form a single viewing device 17, 47 allowing information to be displayed in overlay on a direct view of the landscape outside the aircraft 1.

The image capture devices 15, 45 are positioned so as to capture images of a front zone of the environment of the aircraft 1. The image capture devices 15, 45 are, for example, fastened to the airframe 4 of the aircraft 1 and oriented towards the front of the aircraft 1. The image capture devices 15, 45 may be separate as shown in FIG. 1. The image capture devices 15, 45 may alternatively form a single image capture device. The image capture devices 15, 45 may include, for example, a camera or a photographic device.

The autopilot device 18 is shared by the two systems 10, 40. The autopilot device 18 can act automatically on the control members of the aircraft 1 in order to transmit one or more setpoints to these control members so as to fly along an expected trajectory towards a target point, for example.

The specific memory 12 stores a supervised artificial intelligence configured to identify predetermined objects 20, 30 in the environment of the aircraft 1, and more precisely to identify helipads 20, 25 in the environment of the aircraft 1.

The designated memory 42 stores a supervised artificial intelligence configured to identify predetermined objects 20, 30 in the environment of the aircraft 1, and more precisely to identify cables 30 in the environment of the aircraft 1.

Each of these supervised artificial intelligences may comprise a multilayer neural network provided with at least two hidden layers or a support-vector machine.

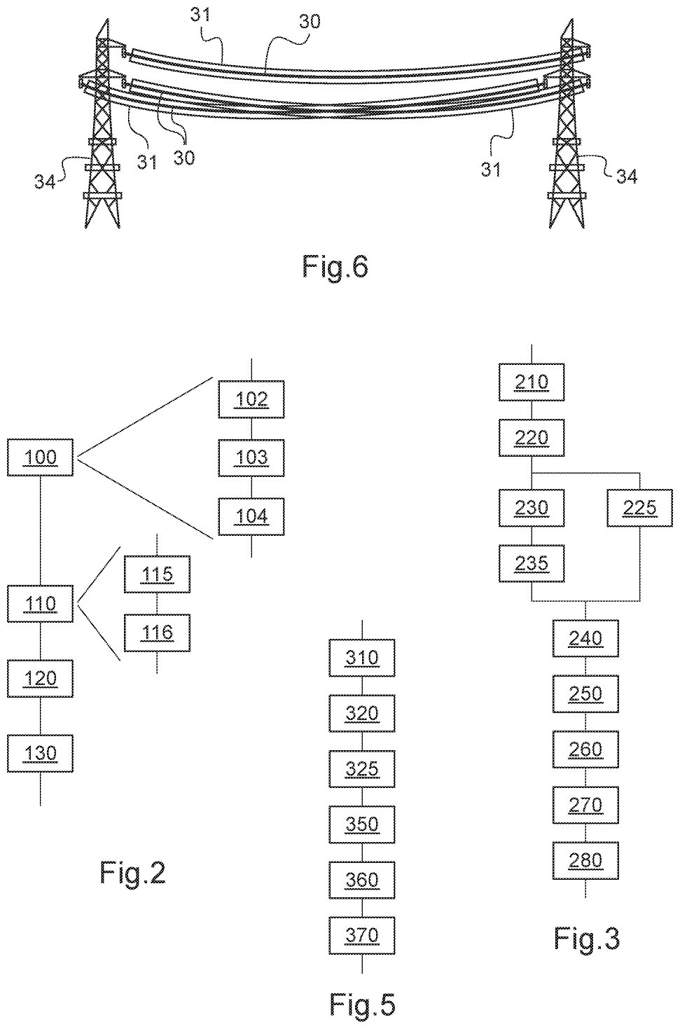

FIG. 2 shows a block diagram relating to a method for training a supervised artificial intelligence to identify a predetermined object, which may be known previously. To reiterate, a predetermined object may, for example, be a helipad 20, 25 or a cable 30 situated in the environment of the aircraft 1.

The method for training the supervised artificial intelligence comprises several steps as follows, carried out by means of a dedicated calculator that may be separate from the on-board calculators 11, 41.

Firstly, a step 100 of identifying at least one predetermined object 20, 30 is carried out by processing the representations representing at least one predetermined object 20, 30 and at least part of its environment. The representations used during this identification step 100 comprise a plurality of representations of the same predetermined object 20, 30 with different values of at least one characteristic parameter of these representations.

The representations may originate from different sources and be of different types. The representations may comprise images captured by an aircraft in flight by a camera or a photographic device, images from a terrain database, or else synthetic images, for example.

These representations may also be limited to predetermined objects located in a given geographical area such as a country, a region or a city.

This at least one characteristic parameter of these representations comprises, for example, an accumulation criterion, a noise criterion for said representation, a similarity factor criterion for these representations, the estimated distance of the predetermined object 20, 30 in each representation, the angle of view relative to the predetermined object, the weather conditions of these representations or indeed the colors, the contrast and/or the brightness of these representations, etc.

The representations as a whole may optionally form a database.

This identification step 100 may comprise sub-steps.

A sub-step of automatically labelling at least one predetermined object may, for example, be carried out by the calculator or may indeed have been carried out beforehand. This labelling comprises at least one labelling parameter for each predetermined object 20, 30, for example the geometric shape of the predetermined object 20, 30, definition parameters of such a geometric shape, such as parameters of the equation defining said geometric shape or its dimensions, and positioning parameters of the predetermined object 20, 30, such as a distance of the predetermined object 20, 30, a focal distance of a lens or a bias of an installation used to capture the predetermined object 20, 30.

A sub-step 102 of processing these representations is carried out, for example, by the calculator by applying one or more image processing methods such as a Sobel filter, a Hough transform, the least squares method, the snake method and the image matching method. This processing sub-step 102 makes it possible to detect, in each representation, at least one parametrizable geometric shape, such as a line segment, an ellipse, a catenary or other particular geometric shapes. A parametrizable geometric shape can be defined by a number of points of the geometric shape that is to be found.

Next, a sub-step 103 of identifying at least one predetermined object 20, 30 in each of the representations is carried out by the calculator, using the parametrizable geometric shape.

An ellipse may correspond to a circle drawn on a helipad 20, 25 and seen at certain angles of view in a representation, and may thus make it possible to identify a helipad 20, 25.

A line segment may also correspond to a circle drawn on a helipad 20, 25 and seen at a long distance according to a representation, and may thus make it possible to identify a helipad 20, 25. A line segment may also correspond to elements of the letter “H” printed on a helipad 20, 25 and may thus make it possible to identify a helipad 20, 25.

Such a line segment may also correspond to a building or to an element of a metal structure situated in the environment of the predetermined object. Similarly, a particular geometric shape may also correspond to such a building or such an element of a metal structure.

A catenary may correspond to a suspended cable 30 and thus make it possible to identify this cable 30.

A sub-step 104 of storing the representation and this at least one identified predetermined object 20, 30 in a memory connected, for example, in a wired or wireless manner to the calculator, is carried out for each of the representations. Each identified predetermined object 20, 30 can be stored with geometric characteristics associated with the parametrizable geometric shape that made it possible to identify this predetermined object 20, 30, namely a line segment, an ellipse, a catenary or a particular geometric shape.

Next, a step 110 of establishing a training set and a validation set is carried out, and comprises two sub-steps.

During a selection sub-step 115, a plurality of representations are selected from all the identified representations in order to form the training set.

During a selection sub-step 116, a plurality of representations are selected from all the identified representations in order to form the validation set.

The sub-steps 115, 116 of selecting the training and validation sets may be carried out according to one or more characteristic parameters of these representations, according to at least one labelling parameter or else by random selection from the representations as a whole.

The selections 115, 116 may be made manually by an operator. These selections 115, 116 may also be made automatically by the calculator, for example as a function of these characteristic parameters of these representations or of a labelling parameter.

Furthermore, the training and validation sets may be identical or else comprise separate representations.

The training and validation sets are then used to feed the supervised artificial intelligence.

Thus, during a training step 120, the training set is used to train the supervised artificial intelligence. During this training step 120, the supervised artificial intelligence is thus trained in order to identify one or more predetermined objects in the representations forming the training set.

Then, during a validation step 130, the validation set is used to validate the supervised artificial intelligence by using the validation set. During a validation step 130, the efficiency and reliability of the supervised artificial intelligence are verified.

This supervised artificial intelligence defined in this way can be stored in the specific memory 12 of the system for assisting the landing of the aircraft 1 such that this system 10, using the specific calculator 11, implements the method for assisting the landing of an aircraft, a block diagram of which is shown in FIG. 3. This method for assisting the landing of an aircraft comprises several steps.

During an acquisition step 210, at least one image of an environment of the aircraft 1 is captured using the specific image capture device 15.

Then, during an identification step 220, at least one helipad, which may be known previously, is identified in the environment by processing said at least one captured image with the supervised artificial intelligence by means of the specific calculator 11.

In this way, the supervised artificial intelligence automatically and rapidly identifies, in the captured images, one or more helipads 20 present in the environment of the aircraft 1, and possibly known previously, by identifying the helipads 20, for example by means of geometric characteristics of the helipads 20, or even characteristic elements of the environment.

The method for assisting the landing of an aircraft may comprise additional steps.

For example, during a display step 225, a first identification marker 21 is displayed on the specific display device 14, as shown in FIG. 4. The first identification marker 21 may be displayed in overlay on each identified helipad 20 in an image representing the environment of the aircraft 1 on the screen 16 or indeed in a direct view of the environment on the viewing device 17 of the helmet 7. In this way, the pilot can view the presence and the position of each helipad 20 present in front of the aircraft 1. The first identification marker 21 is, for example, elliptical in shape. In FIG. 4, the identified helipads 20 are located at the top of a building 50.

During a step 230 of determining at least one helipad 25 available for a landing operation, each helipad 25 available for a landing operation from each identified helipad 20 is determined by the specific calculator 11 by means of the supervised artificial intelligence by analyzing the images captured by the specific image capture device 15. This availability of a helipad 20 is determined, for example, by establishing that the letter “H” printed on the helipad 25 is totally visible.

Next, during a display step 235, a second identification marker 26 may be displayed on the specific display device 14 for each available helipad 25. The second identification marker 26 is displayed in overlay on each available helipad 25 in an image representing the environment of the aircraft 1 on the screen 16 or indeed in a direct view of the environment on the viewing device 17 of the helmet 7. The second identification marker 26 is, for example, in the form of a dot, and may be displayed in a specific color, for example green.

During this display step 235, a third identification marker 29 may be displayed on the specific display device 14 for each helipad 28 occupied by a vehicle and therefore not available for a landing operation. The third identification marker 29 is displayed in overlay on each occupied helipad 28 in an image representing the environment of the aircraft 1 on the screen 16 or indeed in a direct view of the environment on the viewing device 17 of the helmet 7. The third identification marker 29 is, for example, in the form of a cross, and may be displayed in a specific color, for example red.

The method for assisting the landing of an aircraft may also comprise additional steps in order for the aircraft 1 to automatically approach an identified helipad 20, 25, or even automatically land on this helipad 20, 25.

During a selection step 240, a helipad 20, 25 is selected from said at least one identified helipad 20, 25 in order to carry out a landing operation.

This selection may be made manually by a pilot or a co-pilot of the aircraft 1, for example on the screen 16 provided with a touch panel or by means of an associated pointer. This selection may also be made automatically, in particular when only one helipad 20 is identified or when only one helipad 25 of the identified helipads 20 is available.

During a determination step 250, a relative position of the selected helipad 20, 25 is determined with respect to the aircraft 1. This relative position may be determined using the specific calculator 11, the images captured by the specific image capture device 15, and optionally the characteristics of the specific image capture device 15 and/or one or more geometric characteristics of the selected helipad 20, 25.

During a determination step 260, a setpoint for guiding the aircraft to the selected helipad 20, 25 is determined using the specific calculator 11. This setpoint is determined as a function of the relative position of the selected helipad 20, 25 and one or more stored control laws, the guidance setpoint being transmitted to the autopilot device 18.

During an automatic guidance step 270, an approach phase in which the aircraft 1 approaches the selected helipad 20, 25 is carried out automatically by means of the autopilot device 18.

During a final automatic landing step 280, the aircraft 1 can be landed on the selected helipad automatically by means of the autopilot device 18, by applying one or more stored control laws.

The method for assisting the landing of an aircraft may also include a step of calculating a distance between each identified helipad 20, 25 and the aircraft 1 and a step of displaying the calculated distance or distances on the specific display device 14. Each distance is calculated by the specific calculator 11 as a function of one or more geometric characteristics of this helipad 20, 25, the geometric shapes associated with these geometric characteristics represented on said at least one captured image, and the characteristics of the specific image capture device 15.

The supervised artificial intelligence intended to identify a predetermined object may also be stored in the designated memory 42 of the system 40 for assisting cable avoidance with an aircraft 1 such that this system 40, using the designated calculator 41, implements the method for assisting cable avoidance with an aircraft 1, a block diagram of which is shown in FIG. 5. This method for assisting cable avoidance with an aircraft 1 comprises several steps.

During an acquisition step 310, at least one image of an environment of the aircraft 1 is captured using the designated image capture device 45.

Then, during an identification step 320, at least one cable 30, which may be known previously, is identified in the environment by processing said at least one captured image with the supervised artificial intelligence by means of the designated calculator 41.

In this way, the supervised artificial intelligence makes it possible to automatically and rapidly identify, in the captured images, one or more cables present in the environment of the aircraft 1, by identifying the cable or cables, for example geometric characteristics of the cable or cables, or even characteristic elements of the environment.

The method for assisting cable avoidance with an aircraft may comprise additional steps.

For example, during a display step 325, an identification symbol 31 is displayed on the designated display device 44, as shown in FIG. 6. The identification symbol 31 can be displayed in overlay on each identified cable 30 in an image representing the environment of the aircraft 1 on the screen 46 or indeed in a direct view of the environment on the viewing device 47 of the helmet 7. In this way, the pilot can view the presence and the position of each cable 30 present in front of the aircraft 1 or close to its trajectory. The identification symbol 31 has, for example, an elongate shape following the path of the cable 30. In FIG. 6, the identified cables 30 are located high up, between two pylons 34.

The method for assisting cable avoidance with an aircraft may also comprise additional steps in order for the aircraft 1 to follow a trajectory avoiding an identified cable 30, if necessary.

During a determination step 350, a position of each identified cable 30 is determined. This position may be relative to the aircraft 1 or absolute in a terrestrial reference frame, for example.

This position of each identified cable 30 is, for example, determined using the designated calculator 41, the images captured by the designated image capture device 45, and optionally the characteristics of the designated image capture device 45 and/or one or more geometric characteristics of each identified cable 30.

During a determination step 360, a guidance setpoint enabling the aircraft 1 to avoid each identified cable 30 is determined using the designated calculator 41. This setpoint is determined as a function of the position of each identified cable 30 and one or more stored control laws, the guidance setpoint being transmitted to the autopilot device 18.

During an automatic guidance step 370, the aircraft 1 can, by means of the autopilot device 18, automatically follow a trajectory avoiding each identified cable 30, by applying the previously determined guidance setpoint.

The method for assisting cable avoidance may also include a step of calculating a distance between one or more identified cables 30 and the aircraft 1, and a step of displaying the calculated distance or distances on the designated display device 44. Each distance is calculated by the designated calculator 41 as a function of one or more geometric characteristics of this cable 30, the geometric shapes associated with these geometric characteristics represented on said at least one captured image, and the characteristics of the designated image capture device 45.

The aircraft 1 can thus navigate safely while avoiding any cable identified by the system 40 for assisting cable avoidance with an aircraft.

Naturally, the present disclosure is subject to numerous variations as regards its implementation. Although several embodiments are described above, it should readily be understood that it is not conceivable to identify exhaustively all the possible embodiments. It is naturally possible to replace any of the means described with equivalent means without going beyond the ambit of the present disclosure and the claims.

What is claimed is:

1. A method for training a supervised artificial intelligence intended to identify a predetermined object in the environment of an aircraft in flight,
wherein the method includes the following steps carried out using a calculator:
identifying at least one predetermined object by processing representations representing at least one predetermined object and at least part of its environment, the representations comprising a plurality of representations of the same predetermined object with different values of at least one characteristic parameter of the representations;
establishing a training set and a validation set to feed the supervised artificial intelligence, comprising the following sub-steps:
selecting a plurality of representations from the representations to form the training set; and
selecting a plurality of representations from the representations to form the validation set;
training in order to train the supervised artificial intelligence, using at least the training set; and
validating in order to validate the supervised artificial intelligence, using at least the validation set.

2. The method according to claim 1,
wherein the step of identifying at least one predetermined object by processing the representations comprises the following sub-steps:
processing the representations by applying one or more image processing methods from a Sobel filter, a Hough transform, the least squares method, the snake method and the image matching method, in order to identify at least one parametrizable geometric shape;
identifying, in each of the representations, at least one predetermined object, by means of the geometric shape(s); and
storing, for each of the representations, the representation and the identified predetermined object(s).

3. The method according to claim 1,
wherein the characteristic parameter(s) of the representations comprise(s) one or more criteria from an accumulation criterion for the representations, a noise criterion for the representations, a similarity factor criterion for the representations, a distance of the predetermined object in the representations and an angle of view of the predetermined object in the representations, the sub-step of selecting the training set being carried out according to at least one characteristic parameter of the representations.

4. The method according to claim 1,
wherein the step of identifying at least one predetermined object comprises a sub-step of automatically labelling the predetermined object(s), the labelling of the predetermined object(s) comprising at least one labelling parameter from a geometric shape of the predetermined object(s), definition parameters of a geometric shape of the predetermined object(s), positioning parameters of the predetermined object(s), and the sub-step of selecting the training set is performed according to at least one labelling parameter.

5. The method according to claim 1,
wherein the sub-steps of selecting the training set and selecting the validation set are carried out by random selection from the representations, the representations of the validation set being different from the representations of the training set.

6. The method according to claim 1,
wherein the representations are limited to predetermined objects situated in a determined geographical area.

7. The method according to claim 1,
wherein the supervised artificial intelligence comprises a multilayer neural network or a support-vector machine.

8. The method according to claim 1,
wherein the predetermined object, and its geometric characteristics, are known previously.

9. The method for assisting the landing of the aircraft, the aircraft including at least one on-board specific calculator and at least one specific image capture device connected to the specific calculator, the method being implemented by the specific calculator,
wherein the method comprises the following steps:
acquiring at least one image of an environment of the aircraft using the specific image capture device(s); and
identifying at least one helipad in the environment by processing the image(s) with the supervised artificial intelligence by means of the specific calculator, the supervised artificial intelligence being defined using the training method according to claim 1, the predetermined object being a helipad, the supervised artificial intelligence being stored in a specific memory connected to the specific calculator.

10. The method according to claim 9,
wherein the method comprises a step of displaying, on a specific display device of the aircraft, a first identification marker in overlay on the identified helipad(s) in an image representing the environment of the aircraft or indeed in a direct view of the environment through the specific display device.

11. The method according to claim 9,
wherein the method comprises a step of determining at least one helipad available for a landing operation from the identified helipad(s) and a step of displaying, on a specific display device of the aircraft, a second identification marker in overlay on the available helipad(s) in an image representing the environment of the aircraft or indeed in a direct view of the environment through the specific display device.

12. The method according to claim 9,
wherein the method comprises the following additional steps:
selecting a helipad in order to carry out a landing operation on the helipad selected from the identified helipad(s);
determining a position of the selected helipad;
determining a setpoint for guiding the aircraft to the selected helipad using the specific calculator; and
automatically guiding the aircraft towards the selected helipad by means of an autopilot device of the aircraft.

13. The method according to claim 12,
wherein the method includes a final step of automatically landing the aircraft on the selected helipad.

14. The method according to claim 9,
wherein the method comprises a step of calculating a distance between the identified helipad(s) and the aircraft, using the specific calculator as a function of one or more geometric characteristics of the helipad(s), the geometric shapes associated with the geometric characteristics represented in the image(s), and characteristics of the specific image capture device, and a step of displaying, on the specific display device, the calculated distance of the identified helipad(s).

15. The method for assisting the avoidance of a cable with an aircraft, the aircraft including at least one on-board designated calculator and at least one designated image capture device connected to the designated calculator, the method being implemented by the designated calculator,
wherein the method comprises the following steps:
acquiring at least one image of an environment of the aircraft using the designated image capture device(s); and
identifying at least one cable in the environment by processing the image(s) with the supervised artificial intelligence by means of the designated calculator, the supervised artificial intelligence being defined using the training method according to claim 1, the previously known predetermined object being a cable, the supervised artificial intelligence being stored in a designated memory connected to the designated calculator.

16. The method according to claim 15,
wherein the method comprises a step of displaying, on a designated display device of the aircraft, an identification symbol in overlay on the identified cable(s) in an image representing the environment of the aircraft or indeed in a direct view of the environment through the designated display device.

17. The method according to claim 15,
wherein the method comprises the following additional steps:
determining a position of the identified cable(s);
determining a guidance setpoint for the aircraft avoiding the identified cable(s), using the designated calculator; and
automatically guiding the aircraft according to the guidance setpoint by means of an autopilot device of the aircraft.

18. The method according to claim 15,
wherein the method comprises a step of calculating a distance between the identified cable(s) and the aircraft, using the designated calculator as a function of one or more geometric characteristics of the cable(s), the geometric shapes associated with the geometric characteristics represented in the captured image(s), and the characteristics of the designated image capture device, and a step of displaying, on the designated display device, the calculated distance of the cable(s).

19. A system for assisting the landing of an aircraft, the system including:
at least one on-board specific calculator;
at least one specific memory connected to the specific calculator; and
at least one specific image capture device connected to the specific calculator,
wherein the system is configured to implement the method for assisting the landing of an aircraft according to claim 9.

20. An aircraft,
wherein the aircraft comprises the system for assisting the landing of the aircraft according to claim 19.

21. A system for assisting the avoidance of a cable with the aircraft, the system including:
at least one on-board designated calculator;
at least one designated memory connected to the designated calculator; and
at least one designated image capture device connected to the designated calculator,
wherein the system is configured to implement the method for assisting the avoidance of a cable according to claim

15.

22. An aircraft,
wherein the aircraft includes the system for assisting the avoidance of a cable with the aircraft according to claim 21.
